(19) United States
(12) Patent Application Publication
(10) Pub. No.: US 2008/0140964 A1
(43) Pub. Date: Jun. 12, 2008

(54) DIGTAL PHOTO FRAME WITH AUTOMATIC BACKUP FUNCTION

(75) Inventors: Xiao-Guang Li, Shenzhen City (CN); Kuan-Hong Hsieh, Shenzhen City (CN); Han-Che Wang, Shenzhen City (CN); Chun-Wei Pan, Shenzhen City (CN)

Correspondence Address: NORTH AMERICA INTELLECTUAL PROPERTY CORPORATION, P.O. BOX 506, MERRIFIELD, VA, 22116, US

(73) Assignees: ENSKY TECHNOLOGY (SHENZHEN) CO., LTD., Shenzhen City (CN); ENSKY TECHNOLOGY CO., LTD., Taipei Hsien (TW)

(21) Appl. No.: 11/927,694

(22) Filed: Oct. 30, 2007

(30) Foreign Application Priority Data
Dec. 7, 2006 (CN) 200610201228.2

(51) Int. Cl. G06F 12/00

(52) U.S. Cl. 711/162; 711/E12.001

(57) ABSTRACT

A digital photo frame with automatic backup function includes a storage unit; an interface for connecting with an external storage device; and a processing unit. The processing unit includes a detecting module for detecting whether the interface is connected with the external storage device; an obtaining module for obtaining an identification number of the connected external storage device; a search module for searching for a folder corresponding to the external storage device in the storage unit, according to the identification number of the external storage device; a reading module for reading files from the external storage device; and a backup module for backingup the files to the corresponding folder when the search module finds the corresponding folder. Related methods of automatic file backup are also provided.

### BACKGROUND

1. Technical Field

The present invention relates to a digital photo frame and, particularly, to a digital photo frame that can automatically backup files from an external storage device connected to the digital photo frame.

2. General Background

A digital photo frame made of a display has a memory capable of storing several photographs, and can quickly change the photograph to be displayed. A user can change the displayed photograph according to his or her like, which can't be accomplished with a conventional photo frame.

However when the user browses through photographs in the digital photo frame, all photographs are commonly stored together. He or she has to search one by one to find his or her object.

Accordingly, a heretofore need exists in the industry to overcome the aforementioned limitations.

### SUMMARY

A digital photo frame with automatic backup function includes a storage unit, an interface for connecting with an external storage device, and a processing unit. The processing unit includes a detecting module for detecting whether the interface is connected with the external storage device; an obtaining module for obtaining an identification number of the connected external storage device; a search module for searching for a folder corresponding to the external storage device in the storage unit, according to the identification number of the external storage device; a reading module for reading files from the external storage device; and a backup module for backing up the files to the corresponding folder when the search module finds the corresponding folder.

A method of automatic file backup includes the following steps: obtaining an identification number of an external storage device connected to an interface of a digital photo frame; searching for a folder corresponding to the connected external storage device in a storage unit of the digital photo frame, according to the identification number of the external storage device; and reading files from the external storage device and backuping the files to the corresponding folder when the corresponding folder is found.

Other advantages and novel features will be drawn from the following detailed description with reference to the attached drawings.

### BRIEF DESCRIPTION OF THE DRAWINGS

FIG. 1 is an exemplary block diagram of hardware infrastructure of a digital photo frame with an automatic backup function;

FIG. 2 is an exemplary block diagram of main function modules of a processing unit in the digital photo frame of FIG. 1;

FIG. 3 is a flow diagram of an automatic backup method implemented by the digital photo frame in accordance with a preferred embodiment of the invention; and

FIG. 4 is another flow diagram of an automatic backup method implemented by the digital photo frame in accordance with an alternative embodiment of the invention.

### DETAILED DESCRIPTION OF THE EMBODIMENT

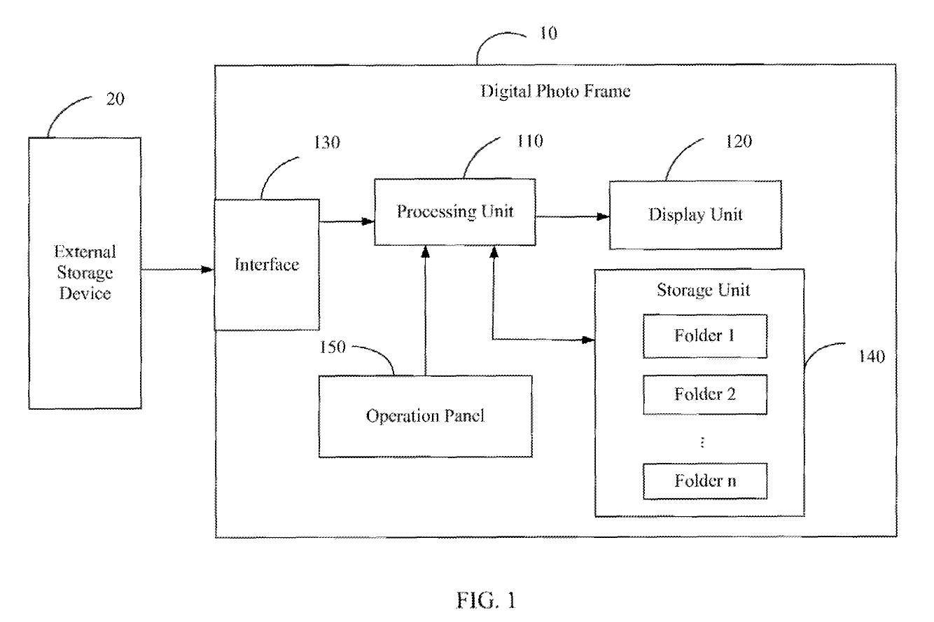

FIG. 1 is an exemplary block diagram of hardware infrastructure of a digital photo frame with an automatic backup function in accordance with a preferred embodiment of the present invention. The digital photo frame 10 includes a processing unit 110, a display unit 120, an interface 130, a storage unit 140, and an operation panel 150.

The interface 130 is used for connecting with an external storage device 20, such as a memory card. The external storage device 20 has a unique identification number for identification. The storage unit 140 is divided into a plurality of storage spaces, namely folder 1, folder 2, . . . , folder n. Each of the folders is created according to a corresponding identification number of the external storage devices 20, and each of the folders can be named with the identification number. For example, when the identification number of the external storage devices 20 is 123456, the name of the corresponding created folder is also 123456.

When the external storage device 20 is connected to the digital photo frame 10 via the interface 130, the processing unit 110 obtains the identification number corresponding to the external storage device 20, and searches for a corresponding folder according to the identification number. If the corresponding folder exists, the processing unit 110 reads files from the external storage device 20 and backups the files to the corresponding folder. If the corresponding folder does not exist, the processing unit 110 creates a new folder corresponding to the connected external device 20, and backups the files to the new folder. The new folder can also be named with the identification number of the external storage device 20.

The processing unit 110 is also connected with the display unit 120 and the operation panel 150. The operation panel 150 supplies a communication between a user and the processing unit 110, for example, the user can operate the files in the storage unit 140 via the operation panel 150, e.g. file selection, file zooming in, file zooming out, and so on. The display unit 120 displays the files.

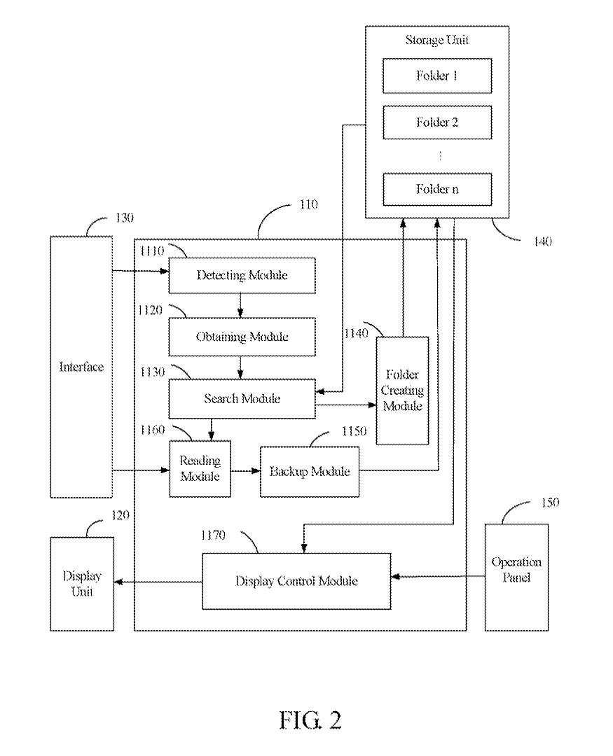

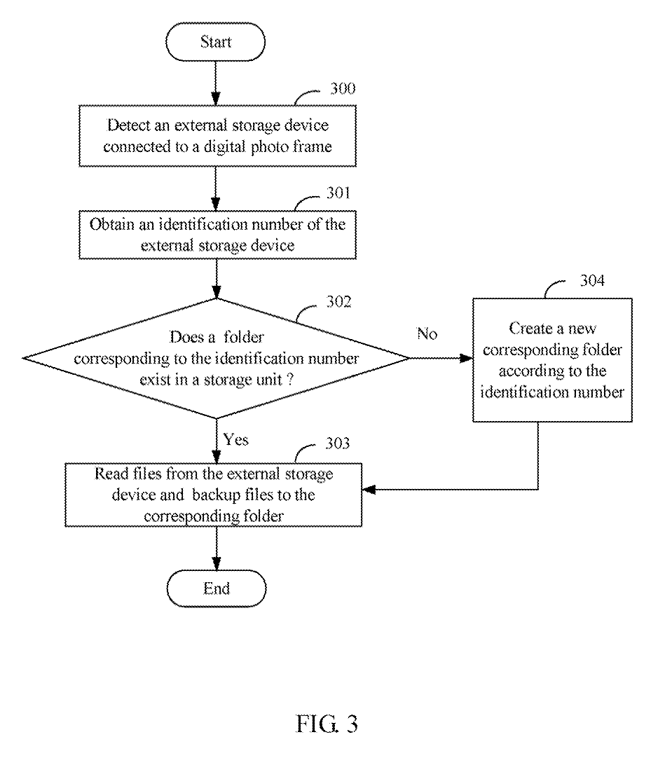

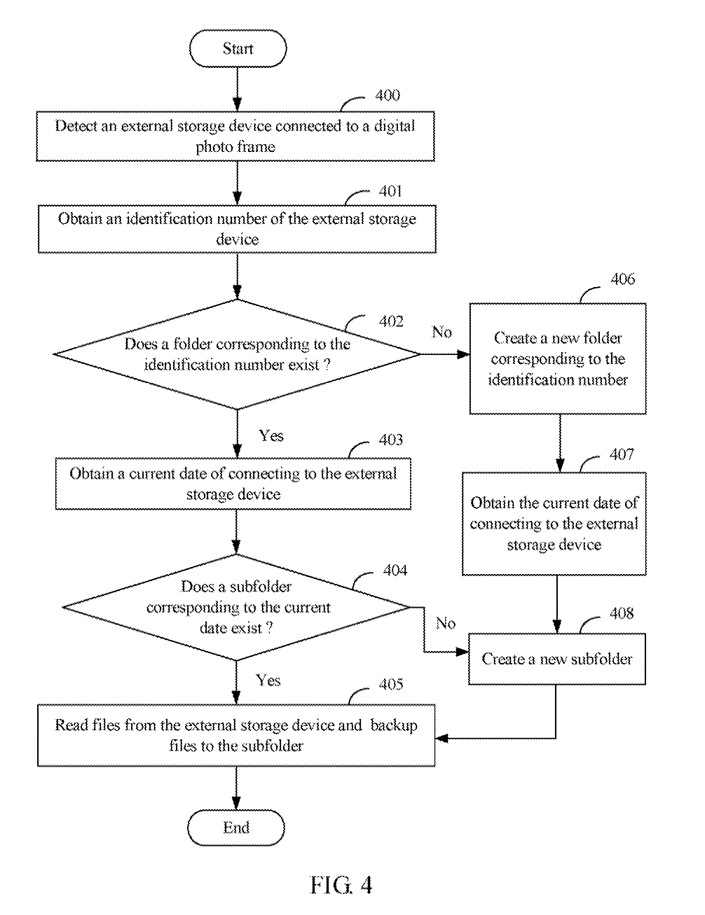

FIG. 2 is an exemplary block diagram of main function modules of the processing unit 110 in accordance with the preferred embodiment of the present invention. The processing unit 110 includes a detecting module 1110, an obtaining module 1120, a search module 1130, a folder creating module 1140, a backup module 1150, a reading module 1160, and a display module 1170. Function of all the modules is depicted as below together with FIG. 3 and FIG. 4.

FIG. 3 is a flow diagram of an automatic backup method implemented by the digital photo frame 10 in accordance with the preferred embodiment of the present invention. In step 300, if the detecting module 1110 detects that the external storage device 20 is connected to the interface 130, it sends an instruction to the obtaining module 1120.

In step 301, the obtaining module 1120 obtains the identification number of the external storage device 20 in response to the instruction of the detecting module 1110, and transmits the identification number to the search module 1130.

In step 302, the search module 1130 searches for the corresponding folder according to the identification number and generates a first search result. If the first search result does not show a corresponding folder, the search module 1130 sends the first search result to the folder creating module 1140. If the first search result shows a corresponding folder, the search module 1130 sends the first search result to the reading module 1160.

In step 303, when the reading module 1160 receives the first search result, the reading module 1160 reads the files in the external storage device 20 and transmits the read files to the backup module 1150. The backup module 1150 backups the read files in the corresponding folder.

In step 304, when the folder creating module 1140 receives the first search result, the folder creating module 1140 creates a new corresponding folder and names the new corresponding folder with the identification number of the external storage device 20, and the procedure goes to step 303 described above. The display module 1170 is connected with the operation panel 150 and the display unit 120, and is for transmitting the files to the display unit 120.

FIG. 4 is another flow diagram of the automatic backup method implemented by the digital photo frame 10 in accordance with an alternative embodiment of the present invention. In step 400, the detecting module 1110 detects whether the external storage devices 20 is connected to the interface 130, and sends the instruction to the obtaining module 1120 when detecting the external storage devices 20.

In step 401, the obtaining module 1120 obtains the identification number of the external storage devices 20 in response to the instruction from the detecting module 1110, and transmits the identification number to the search module 1130.

In step 402, the search module 1130 searches for the corresponding folder according to the identification number and generates the first search result. If the first search result does not show a corresponding folder, the search module 1130 sends the first search result to the folder creating module 1140, and the procedure goes to step 406. If the first search result shows a corresponding folder, the search module 1130 sends the first search result to the reading module 1160.

In step 403, when the reading module 1160 receives the first search result, the obtaining module 1120 obtains a current date when connecting with the external storage device 20.

In step 404, the search module 1130 searches for a corresponding subfolder according to the current date and generates a second search result. If the first search result does not show a corresponding subfolder, the search module 1130 sends the second search result to the folder creating module 1140, and the procedure goes to step 408. If the first search result shows a corresponding subfolder, the search module 1130 sends the second search result to the reading module 1160.

In step 405, when the reading module 1160 receives the second search result, the reading module 1160 reads the files from the external storage device 20 and transmits the files to the backup module 1150. The backup module 1150 backups the files in the corresponding subfolder.

In step 406, the folder creating module 1140 creates a new corresponding folder and names the new corresponding folder with the identification number of the external storage device 20. In step 407, the obtaining module 1120 obtains the current date.

In step 408, when the folder creating module 1140 receives the second search result, the folder creating module 1140 creates a new corresponding subfolder and names the new corresponding subfolder with the current date, and the procedure goes to step 405 described above.

Although the present invention has been specifically described on the basis of a preferred embodiment including preferred methods thereof, the invention is not to be construed as being limited thereto. Various changes or modifications may be made to the embodiment including the methods without departing from the scope and spirit of the invention.

What is claimed is:

1. A digital photo frame with an automatic backup function, the digital photo frame comprising:
a storage unit;
an interface for connecting with an external storage device; and
a processing unit comprising:
a detecting module for detecting whether the interface is connected with the external storage device;
an obtaining module for obtaining an identification number of the connected external storage device;
a search module for searching for a folder corresponding to the external storage device in the storage unit, according to the identification number of the external storage device;
a reading module for reading files from the external storage device; and
a backup module for backingup the files to the corresponding folder when the search module finds the corresponding folder.

2. The digital photo frame according to claim 1, further comprising a folder creating module for creating a new folder corresponding to the external storage device, when the search module does not find the corresponding folder.

3. The digital photo frame according to claim 2, wherein the folder creating module further creates a subfolder of the corresponding folder according to a current date of connecting with the external storage device, and the backup module backups files to the subfolder.

4. The digital photo frame according to claim 2, wherein the new folder is named with the identification number of the external storage device.

5. The digital photo frame according to claim 3, wherein the subfolder is named with the current date of connecting with the external storage device.

6. A method of automatic backup files comprising:
obtaining an identification number of an external storage device connected to an interface of a digital photo frame;
searching for a folder corresponding to the connected external storage device in a storage unit of the digital photo frame, according to the identification number of the external storage device; and
reading files from the external storage device and backingup the files to the corresponding folder when the corresponding folder is found.

7. The method of automatic backup according to claim 6 further comprising creating a new folder corresponding to the connected external storage device according to the identification number of the external storage device and backingup the read files to the new folder when no corresponding folder is found.

8. The method of automatic backup according to claim 6 further comprising creating a new subfolder corresponding to the folder according to a current date of connecting with the external storage device and backuping the read files to the new subfolder.
